(19) United States
(12) Patent Application Publication
(10) Pub. No.: US 2024/0054370 A1
(43) Pub. Date: Feb. 15, 2024

(54) SYSTEM, METHOD AND COMPUTER PROGRAM PRODUCT FOR AUTOMATIC RECOGNITION OF WORK CYCLES OF A CIVIL ENGINEERING MACHINE

(71) Applicant: Liebherr-Werk Nenzing GmbH, Nenzing (AT)

(72) Inventors: Michael MARENT, Schlins (AT); Aleksej STANGE, Bürs (AT)

(21) Appl. No.: 18/446,138

(22) Filed: Aug. 8, 2023

(30) Foreign Application Priority Data
Aug. 10, 2022 (DE) 10 2022 120 182.1

(51) Int. Cl. G06N 7/00; G06N 20/00

(52) U.S. Cl. CPC G06N 7/00; G06N 20/00

(57) ABSTRACT

The disclosure relates to a system and a method for automatic recognition of work cycles of a civil engineering machine, comprising a data storage, a detection device, a cycle phase recognition device and a cycle allocation device. A classification model, which has been generated automatically by a mathematical optimization method, is stored on the data storage. By means of the detection device, status data concerning at least one state of the civil engineering machine can be detected. The cycle phase recognition device has access to the data storage, receives machine data as input data, the machine data being based on the status data detected by the detection device. The cycle phase recognition device is configured to automatically allocate machine data to a first cycle phase based on the classification model, the latter corresponding to a defined work process of the civil engineering machine.

### CROSS REFERENCE TO RELATED APPLICATION

The present application claims priority to German Patent Application No. 10 2022 120 182.1 filed on Aug. 10, 2022. The entire contents of the above-listed application are hereby incorporated by reference for all purposes.

### TECHNICAL FIELD

The present disclosure relates to a system for automatic recognition of work cycles of a civil engineering machine, a civil engineering machine, a method for automatic recognition of work cycles of a civil engineering machine by means of such a system, and a corresponding computer program product.

### BACKGROUND

Typical work sequences of civil engineering machines such as rotary drilling rigs, trench wall milling machines or vibratory pile drivers are usually subdivided into work cycles, whereby each cycle may consist of several work steps. In civil engineering, a cycle is usually defined by the fact that a desired final depth is reached at the end of the cycle. Examples here can be the jogging of piles to a certain driving depth with a vibratory pile driver or the reaching of a certain drilling depth with a trench wall cutter or a kelly drilling rig.

FIG. 1 shows an example of a possible work cycle in kelly drilling, where the black line represents the instantaneous depth of the drilling tool detected via sensors as a function of time. The dashed line represents the ground level, while the circles 30 represent measurement points detected during active drilling.

In kelly drilling, a cycle 60 (hereinafter also referred to as work cycle 60) is composed of several drilling steps 61, between which cased material is drilled (phase 50 “Casing”). Each drilling step 61 in turn comprises several drilling phases 30, in which progressively deeper drilling is carried out and between which the drilled material is unloaded (phase 40 “Unloading”). The work cycle 60 ends when a specified final depth is reached.

In many civil engineering applications, the machine operator currently manually determines when a cycle begins and ends. This has several disadvantages. On the one hand, the manual marking of the cycle represents an additional effort for the machine operator. In addition, it can happen that the machine operator forgets to enter the start or stop signal. On the other hand, the start or end of the cycle is arbitrarily determined by the machine operator. For example, the start of the cycle can be entered before the actual start of work, or the stop input is made when the machine operator has already left his final depth.

It becomes particularly intransparent in the case of temporally overlapping cycles. FIG. 2 shows an example of the creation of a multiple pile during Kelly drilling, with the circles 30 again indicating the active drilling or the respective drilling phases 30. Here, the machine operator starts a first work cycle 71. Without completing this or reaching the defined final depth, he switches to a second work cycle 72, whereby the drilling depth decreases abruptly. The machine operator completes this second cycle 72, at a greater drilling depth than the depth last reached in the first cycle 71, and then resumes the first cycle 71, again with the drilling depth changing abruptly. Correct manual marking of the various interlocking cycles 71, 72 is particularly complicated and error-prone here.

Furthermore, due to the fact that currently only the start and end times of the entire cycles are usually detected, it is unknown over which time range the individual phases within a cycle extend—e.g. the individual drilling phases 30 in FIGS. 1 and 2.

In many cases, however, there is no information at all on the individual work cycles, i.e. so far also no possibility of defining them manually by the machine operator.

### SUMMARY

Against this background, the present disclosure is based on the object of facilitating the detection of work cycles and, in particular, also of working phases within the work cycles in civil engineering machines. In particular, a simple and reliable detection of the beginning and the end of individual cycles and also of individual work phases within the cycles is to be made possible.

According to the disclosure, this object is achieved by means of a system having the features as described herein.

Accordingly, a system for automatic recognition of work cycles of a civil engineering machine is provided, which comprises a data storage device, a detection device, a cycle phase recognition device and a cycle allocation device. The civil engineering machine may be, for example, a Kelly drilling rig, a drilling rig for continuous flight auger drilling, double-head drilling or full displacement drilling, a trench wall cutter (or a carrier with such a cutter), or a vibratory pile driver, although this list is not to be understood as exhaustive, since many other drilling and deep foundation methods exist in which the method according to the disclosure may also be used.

A classification model, which has been generated automatically by a mathematical optimization process, is stored in the data storage. The classification model is therefore not an a priori defined rule-based algorithm with a predetermined allocation rule (for example, in the form “if measured value X>limit value Y, then allocate measured value X to category Z”). Rather, the classification model is the result of a machine optimization process, the result of which, in particular, cannot be foreseen in advance and only emerges from the optimization process.

By means of the detection device, status data concerning at least one status of the civil engineering machine can be detected, for example a position, an orientation, a pressure in an actuator, a motor speed, etc. The status data can be prepared or processed before further processing, if necessary. If necessary, the status data can be prepared or processed before further processing. It is also conceivable that the data can be forwarded directly (streaming) or initially stored temporarily on the civil engineering machine or externally.

The cycle phase recognition device has access to the data storage and is especially capable of loading the classification model from the data storage. The cycle phase recognition device receives machine data as input data, the machine data being based on the status data detected by the detection device. This may mean that the status data is first processed as raw data and converted into machine data. However, it is also conceivable that the machine data corresponds to the status data (i.e. without intermediate processing or preparation).

The cycle phase recognition device is configured to automatically allocate machine data to a first cycle phase based on the classification model, the latter corresponding to a defined work process of the civil engineering machine. The defined work process may represent, for example, a drilling phase characterized by active drilling of a tool. The machine data allocated to the first cycle phase may represent a subset of the total machine data detected or provided (i.e., only a portion of the machine data is allocated to the first cycle phase). Thus, the allocation occurs automatically based on the machine-generated classification model. The rules according to which the allocation to the first cycle phase is made were created according to the mathematical optimization procedure and depend in particular on the design and type of the civil engineering machine as well as on the area or type of use. The classification model can thus be specifically adapted to the respective civil engineering machine and the work process. Furthermore, data from several different machines can be used to generate the classification model. This makes it possible to use the classification model for several machines and areas of application or construction sites at the same time.

Machine data that cannot be allocated to the first cycle phase, for example because they belong to another cycle phase (e.g. emptying or piping), can either be disregarded for further processing or allocated to a second (or further) cycle phase and subsequently processed. The following explanations for machine data allocated to the first cycle phase can therefore apply analogously to machine data allocated to further cycle phases.

The cycle allocation device receives the machine data allocated to the first cycle phase as input values and is configured to automatically allocate these machine data to a work cycle of the civil engineering machine using a defined allocation rule. The work cycle is defined by start and end values of at least one measured variable represented by the machine data. These start and end values can either be fixed or determinable (for example by the machine operator) or can be determined permanently, systematically and automatically by the automatic recognition. The measured variable can be an insertion depth or drilling depth, i.e. the start and end values can represent a start depth and an end depth. The allocation of the machine data allocated to the first cycle phase to a work cycle is therefore not carried out based on the classification model or another algorithm created by machine using mathematical optimization methods, but based on a “classic” rule-based algorithm with predetermined allocation rules or, in particular, rules defined from the outset.

Thus, the core idea of the present disclosure is to implement automatic cycle recognition using a combination of a “classical” rule-based approach and an allocation using a machine-generated classification algorithm. The allocation to the first cycle phase is performed based on the classification model, since a definition of rigid rules for such an allocation is complex and usually insufficient—the rules for a clean allocation differ from machine to machine. The rule-based approach for allocation to a work cycle is used because allocation based on a machine-generated classification algorithm cannot be readily applied to the entire cycle recognition. In contrast, the combination of these two approaches according to the disclosure enables reliable automatic recognition and allocation of cycle phases and work cycles. As a result, various parameters can be calculated over a cycle and several cycles can be compared with each other. In kelly drilling, for example, this means detecting the start of the first drilling step until the final depth is reached for single and multiple piles and, in the process, the individual drilling areas (i.e. phases of active drilling).

The data storage can be located in the civil engineering machine so that, for example, a control system of the civil engineering machine has access to the data storage. It is also conceivable that the data storage is located in an external computer unit, which preferably has a direct or indirect communicative connection, e.g. wired or wireless, with the civil engineering machine. Furthermore, the data storage could represent a cloud or be part of a cloud application, so that a computer of the civil engineering machine and/or an external computer unit has wireless or wired access to the data storage.

The cycle phase recognition device and/or the cycle allocation device may be implemented by a software module executed by a processor, e.g., by the control system of the civil engineering machine, by an external computing unit (e.g., in a PC or in a mobile device such as tablet, smartphone, etc.), or in a cloud.

In one possible embodiment, it is provided that the classification model was generated using a machine learning method, in particular a supervised machine learning method. The training data for generating the classification model are previously detected machine data of the civil engineering machine and known cycle phases, i.e. historical machine data and known cycle phase ranges of the data are used for training the algorithm. A gradient boosting model can be used as a machine learning method, e.g. XGBoost. This “learning process” is in particular not an active part of the cycle recognition according to the disclosure, but is necessary to build up the classification model.

In a further possible embodiment, it is provided that the detection device comprises at least one sensor attached to the civil engineering machine, which detects a state variable of the civil engineering machine, in particular continuously. The continuous detection may represent a streaming operation (i.e., an actual real-time continuous detection and transmission of the data) or a detection at regular time intervals.

In another possible embodiment, it is provided that the detection device comprises one or more of the sensors described below.

A sensor may be provided for detecting a rope speed, such as a kelly rope speed in a kelly drilling rig or a rope speed of a rope from which a trench wall cutter is suspended.

Alternatively or additionally, a sensor can be provided to detect a rope force, for example a kelly rope force in a kelly drilling rig or a rope force of a rope from which a trench wall cutter is suspended.

Alternatively or additionally, a sensor can be provided for detecting a drive pressure, in particular a drilling drive pressure (for example, a drive pressure of a Kelly drilling drive or a drive for milling wheels of a trench wall milling machine).

Alternatively or additionally, a sensor can be provided for detecting a drive speed, in particular a drilling drive speed (for example, a speed of a Kelly drilling drive or a drive for milling wheels of a trench wall milling machine).

Alternatively or additionally, a sensor can be provided for detecting a control signal, for example a control signal for a drive, in particular for a drilling drive (e.g. control signal-left drilling or right drilling).

Alternatively or additionally, a sensor for detecting a speed and/or a pressure of a drive of an excitation cell of a vibratory pile driver (e.g., a high-tilt vibrator) may be provided.

Alternatively or additionally, a sensor can be provided for detecting a feed rate and/or feed force of a feed carriage (for example, a feed carriage of a kelly drilling rig that is displaceably mounted on a leader and carries the drill drive).

Alternatively or additionally, a sensor for detecting a current position of the civil engineering machine can be provided, for example a GPS module.

Alternatively or additionally, a sensor can be provided for detecting an orientation of the civil engineering machine, for example a rotation angle of an upper carriage of the civil engineering machine rotatably mounted on an undercarriage.

Depending on the machine type and application, several of the aforementioned sensors can be provided in varying numbers and combinations.

In another possible embodiment, it is provided that the defined work process, depending on the application, comprises a drilling process, a casing process (i.e., in particular, the insertion of a support tube into the ground), an unloading process (for example, an unloading of a drilling tool), a jolting or (for example, vibrating a pile by means of a vibrator or a vibrating pile driver), a pile driving process (for example, driving a pile by means of a hydraulic hammer), or a milling process (for example, creating a soil slot by means of a trench wall milling machine).

In a further possible embodiment, it is provided that the cycle phase recognition device is configured to allocate machine data to at least two different cycle phases based on the classification model. These different cycle phases preferably correspond to different defined work processes (e.g. drilling and/or unloading and/or piping). This allows more information about the work process of the civil engineering machine to be collected reliably and automatically and a wider range of characteristics to be calculated. Here, the cycle allocation device is configured to allocate the machine data allocated to a specific cycle phase to a work cycle of the civil engineering machine in each case based on a defined allocation rule. The different cycle phases can belong to a single or common work cycle or to different work cycles and be allocated accordingly.

It is also conceivable that the cycle phase recognition device is configured to allocate machine data to only one cycle phase (first cycle phase) associated with a defined work process based on the classification model and to allocate all machine data that cannot be allocated to this cycle phase to another class (e.g. “remaining work process”) without a defined work process being associated with it.

In another possible embodiment, it is provided that the start and end values defining a work cycle relate to a drilling depth, a placement depth, a position of the civil engineering machine and/or an orientation of the civil engineering machine. In particular, the end of a work cycle may be defined by reaching or exceeding a certain depth.

In a preferred embodiment, it can be provided that the cycle allocation device is configured to allocate machine data of a cycle phase to a work cycle if a difference, in particular a smallest difference, between a GPS position of the currently detected cycle phase and a GPS position of a previous work cycle is smaller than a specified limit value.

Alternatively or additionally, it can be provided that the cycle allocation device is configured to allocate machine data of a cycle phase to a work cycle if a difference, in particular a smallest difference, between a rope length of the currently recognized cycle phase and a rope length of a previous work cycle is smaller than a specified limit value.

Alternatively or additionally, it can be provided that the cycle allocation device is configured to allocate machine data of a cycle phase to a work cycle if a difference, in particular a smallest difference, between a rotation angle of the currently detected cycle phase and a rotation angle of a previous work cycle is smaller than a specified limit value.

In a further possible embodiment, it is provided that the cycle allocation device is configured to store at least part of the machine data allocated to a specific work cycle in an associated data structure. The data structure may be a structured data set in which the machine data are stored in a structured manner. In this case, a separate data structure is allocated to each recognized work cycle, so that the machine data belonging to a specific work cycle are stored in the corresponding data structure and the machine data for a specific work cycle can be retrieved again at a later time.

The cycle allocation device is preferably configured to store the data structures in a data storage and read them out from it, and has corresponding access to the data storage. The data storage can be provided locally in the civil engineering machine, in an external computer unit (e.g. in a PC or in a mobile device such as tablet, smartphone, etc.) or in a cloud. It can be the data storage in which the classification model is also stored, or it can be another data storage.

In a further possible embodiment, it is provided that at least the detected start and end values of a measured variable contained in the machine data, in particular detected start and end drilling depths or start and end insertion depths, are stored in the data structures. Preferably, the time stamps associated with these start and end values are also stored in the data structures. From each complete data structure, it is therefore possible to read out in retrospect in particular which start and end depths were reached in the relevant work cycle and at what times. The time duration of the work cycle can also be extracted from the time stamps.

Preferably, in addition to these start and end values, further machine data is stored in the data structures, for example data concerning a detected fuel consumption, a detected position and/or a detected engine power of the civil engineering machine. This data can be stored together with associated time stamps, if necessary.

Optionally, in addition to the start and end values, all intermediate values can also be stored, i.e., for example, all detected drilling or insertion depths between a start depth and an end depth. These values can be stored together with the associated time stamps.

In a further possible embodiment, it is provided that the cycle allocation device is configured to load a predetermined number of stored data structures from a data storage when new machine data is provided. If necessary, these loaded data structures can be further filled with new machine data, for example during the creation of multiple piles, in which cycles are interrupted and later resumed. Likewise, a cycle can be resumed in this way and the relevant machine data stored in the associated data structure if the machine operator's workday has ended before he was able to complete the cycle and the work cycle was subsequently aborted.

In the case that the machine data are allocated to an already at least partially detected work cycle, i.e. a work cycle for which there is already a data structure at least partially filled with machine data that has been loaded from the data storage, the new machine data are stored in the “old” or loaded data structure, thus completing it if necessary.

If, on the other hand, the machine data cannot be allocated to any of the previously recognized or detected work cycles, i.e. the machine data do not belong to any of the data structures loaded from the data storage, a new data structure is created for this work cycle and the said machine data are stored in the new data structure.

The generation and/or loading and/or storing of the data structures may be performed by the cycle allocation device itself or by a data organization means, the latter communicating with the data storage and the cycle allocation device and constituting a software module.

The disclosure further relates to a civil engineering machine with a detection device of the system according to the disclosure, i.e. the civil engineering machine has in particular at least one of the above-mentioned sensors for the detection of status data, which are fed to the cycle phase recognition device. In principle, the cycle phase recognition device and/or the cycle allocation device need not be implemented in the civil engineering machine, but can be executed on an external computer unit or cloud, with the corresponding data exchange with the civil engineering machine preferably being wireless. It is also conceivable that the cycle phase recognition device and/or the cycle allocation device are executed on a controller of the civil engineering machine, i.e. locally. The data storage for the classification model and/or the data storage in which the data structures are archived may be implemented in the civil engineering machine or externally, again preferably with wireless exchange of the corresponding data. With regard to the properties, advantages and possible embodiments of the system according to the disclosure or the individual components of the system, the previous explanations apply analogously, so that a repetitive description is dispensed with.

The concept presented here with the dynamically writable data structures makes it possible to compare the machine data of the current work cycle with the machine data of the previous work cycles stored in the data structures and to allocate them if necessary or to generate a new data structure accordingly. If the machine data can be allocated to one of the “old” or loaded work cycles, then either the last end values of the loaded data structure can be overwritten with the new machine data or the new machine data can be appended to the loaded data structure. In principle, the stored machine data/work cycles can go back any length of time. This means that “old” work cycles can also be updated again—the number of work cycles that can be overwritten is limited in particular by the number of cycles selected when the data storage is read out. The dynamically writable data structures allow in particular a reliable, automatic detection of multiple piles.

The disclosure further relates to a method for automatic recognition of work cycles of a civil engineering machine by means of a system according to the disclosure. The method comprises the following steps:
Providing a classification model that has been machine-generated by a mathematical optimization procedure,
Providing machine data based on condition data regarding a condition of the civil engineering machine detected by a detection device of the civil engineering machine,
Allocating machine data to a first cycle phase based on the classification model, wherein the first cycle phase corresponds to a defined work process of the civil engineering machine,
Allocating the machine data which have been allocated to the first cycle phase to a work cycle of the civil engineering machine based on a predetermined allocation rule, wherein the work cycle is defined by (in particular fixed or fixable) start and end values of at least one measured variable represented by the machine data.

The explanations of the advantages, properties and possible embodiments of the system according to the disclosure apply analogously to the method according to the disclosure. A repetitive description is therefore dispensed with.

In one possible embodiment, it is provided that at least part of the machine data allocated to a particular work cycle are stored in an associated data structure, wherein each recognized work cycle is allocated its own data structure. Preferably, each completely filled data structure contains at least the detected start and end values of a measured variable contained in the machine data, in particular detected start and end drilling depths or start and end insertion depths, and in particular associated time stamps.

In another possible embodiment, it is provided that a predetermined number of stored data structures are loaded when new machine data are made available. Here again, a distinction can be made between two cases:

If the new machine data can be allocated to a previously identified work cycle, i.e. a work cycle that is represented by a loaded data structure that is already at least partially filled with machine data, the new machine data is stored in the corresponding loaded data structure. If, on the other hand, the new machine data cannot be allocated to a previously identified work cycle, i.e. if no loaded data structure exists for the current work cycle, a new data structure is created for this work cycle and the new machine data is stored in the new data structure.

The disclosure further relates to a computer program product comprising instructions which, when the program is executed, cause the steps of the method according to the disclosure to be carried out. The steps are at least partially executed by components of the civil engineering machine (in particular, the detection of the status data by a detection device or by sensors). In particular, all steps of the method according to the disclosure can be executed locally in the civil engineering machine, for example if the corresponding cycle phase recognition device and cycle allocation device are executed locally in the machine, e.g. by a control system.

### BRIEF DESCRIPTION OF THE FIGURES

Further features, details and advantages of the disclosure will be apparent from the exemplary embodiment explained below with reference to the figures. The Figures show in:

FIG. 1: an example of a time curve of the drilling depth in kelly drilling plotted against a work cycle when constructing a single pile;

FIG. 2: an example of a time curve of Kelly drilling depth plotted against multiple work cycles when constructing a multiple pile; and

FIG. 3: a schematic representation of the system according to the disclosure according to a preferred embodiment.

### DETAILED DESCRIPTION

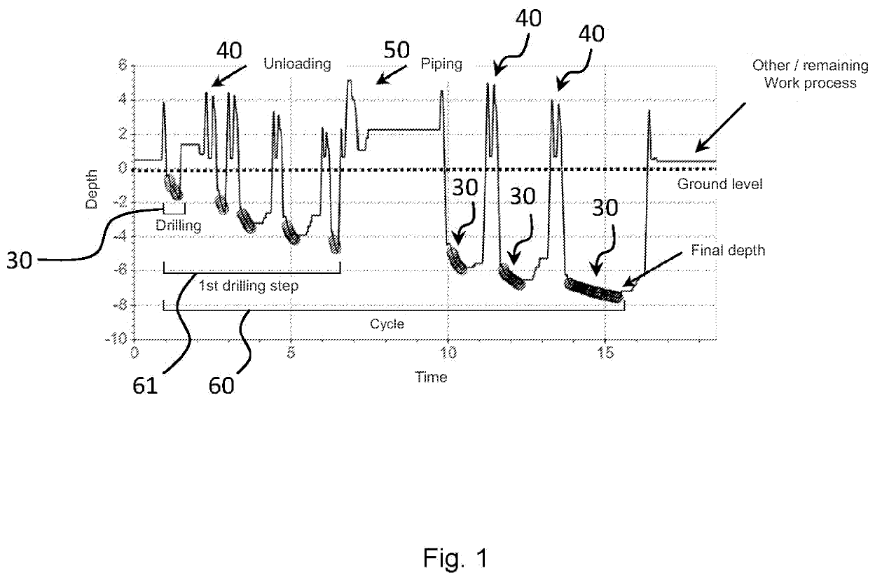

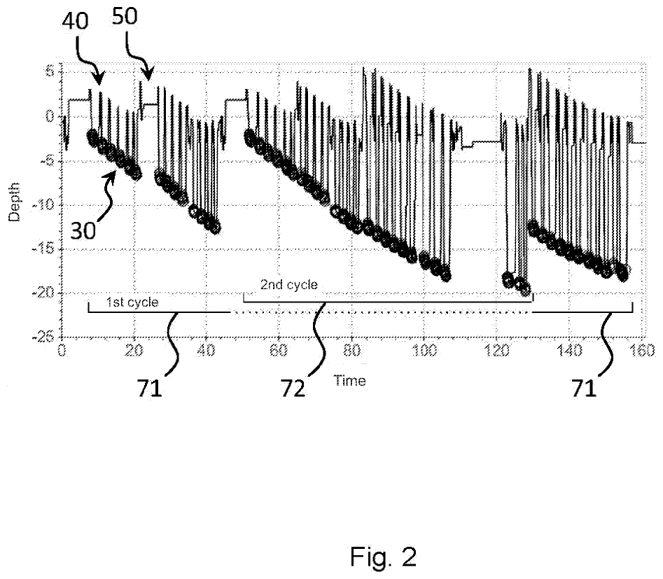

FIGS. 1 and 2 show exemplary time curves of the drilling depth during kelly drilling of a single pile (FIG. 1) and a multiple pile (FIG. 2) and have already been explained at the beginning. A repetitive description will therefore be omitted here.

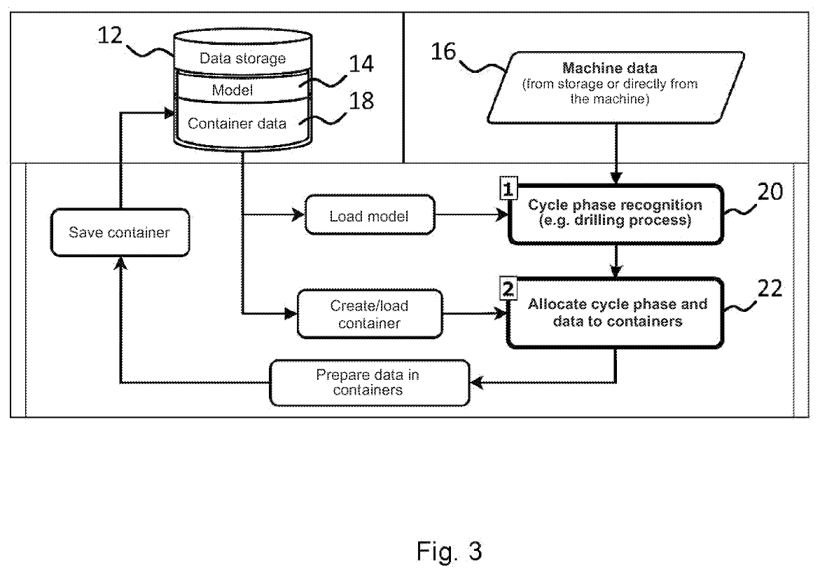

FIG. 3 schematically illustrates a preferred embodiment of the system according to the disclosure.

The process of automatic cycle recognition according to the disclosure comprises two main steps: a cycle phase recognition by a cycle phase recognition device 20 and a cycle allocation by a cycle allocation device 22. Here, the cycle recognition is described using the example of kelly drilling, wherein the relevant cycle phase (=first cycle phase) in this embodiment is the drilling process 30. However, the method according to the disclosure can also be used for other deep foundation work, for example, for milling by means of a trench wall milling machine or for vibrating in pile-driving material by means of a vibratory pile driver.

In the first step, drilling process recognition is performed using a classification model 14. The model 14 is stored in a data storage 12 and is loaded by the cycle phase recognition device 20. The cycle phase recognition device 20 receives machine data 16 as input values and allocates them to the first cycle phase or drilling process 30 based on the classification model 14. The machine data 16 is based on status data (i.e., raw sensor data) measured by sensors of a detection device of the civil engineering machine, which has been “prepared” or processed for further processing.

In the embodiment example shown here, the classification model 14 maps the prepared sensor data or the machine data 16 to the classes “drilling process 30” or “remaining process”. In other words, the classification model 14 is in this case able to check whether measured values of the machine data are to be allocated to the drilling process 30 or not. In FIG. 1, the circles symbolize the data points of the class “drilling process” 30, the remaining data points or the remaining signal course belongs to the class “remaining process” (no defined work process has to be associated with this class, i.e. it does not have to be defined what the machine does in the area “remaining process”, cf. FIG. 1 far right). In an alternative embodiment, in addition to an allocation to the drilling process 30, allocations could also be made to one or more further cycle phases, each of which belongs to a defined work process, for example to the cycle phases “unloading 40” and/or “piping 50”.

The corresponding mapping rule of the model 14 is learned in advance using historical machine data 16. More precisely, based on prepared sensor data with known drilling process areas 30, the mapping rule is determined by a mathematical optimization procedure (i.e. the time areas of the drilling processes 30 must in particular be manually determined in advance—input and output must be known; the relationship between them is determined mathematically). This model 14 is generated according to machine learning principles. Here, a machine learning algorithm automatically or autonomously determines the corresponding rules for the allocation of the machine data 16 to the drilling process 30 and generates the classification model 14 based on the training data. A gradient boosting model is preferably used for this, although other machine learning methods are also conceivable.

For the drilling process detection by the cycle phase recognition device 20, the following measured variables are used as sensor or machine data 16 in the present embodiment:
Kelly rope speed,
Kelly Rope Power,
drill drive pressure,
drill drive speed,
drive signal left drilling,
drive signal right drilling.

In the second step, the detected or allocated drilling process data points 30 of the machine data 16 are allocated to respective work cycles 60 by the cycle allocation device 22 using a “classical” rule-based algorithm. Here, a current drilling process data point 30 is compared to the drilling process data points 30 of past cycles 60 according to predetermined rules, preferably using a predetermined number of past cycles 60 (e.g., the last ten cycles 60, although of course more or less than ten cycles may be used) for the comparison. On this basis, a decision is made as to whether a new cycle 60 is to begin, whether an existing cycle 60 is still active, or whether a cycle 60 that has already been completed is to be resumed. In this way, multiple piles can also be detected, for example.

In the present embodiment example, the defined rules use the following measured variables as sensor or machine data 16:
Kelly pitch,
rotation angle,
GPS positions.

The defined rules are preferably based on the comparison of the detected measured values of the current machine data 16 with certain limit values and/or with stored measured values of past cycles and/or cycle phases. Here, for example, an end depth does not necessarily have to be known and/or defined. Instead, it can be provided that an end depth is only determined by the automatic recognition.

For example, maximum permissible deviations can be defined as limit values (e.g. between the rope lengths of two successive cycle phase data points).

The drilling process data points 30 are collected in a “container” 18 (=structured data set or data structure; hereinafter these terms are used interchangeably) per cycle 60. This is preferably done by the cycle allocation device 22. At least the start and end timestamps of a cycle 60 as well as the associated start and end drilling depths are detected in the cycle containers 18. In addition, further data such as fuel consumption, GPS positions or engine power can be detected in parallel in the cycle containers 18 and characteristic values calculated therefrom.

When no more machine data 16 are available, the cycle detection concludes and the cycle containers 18 are stored in the data storage 12. As soon as new machine data 16 are available (e.g. because the work process of the civil engineering machine is continued), a defined number of active cycle containers 18 (e.g. the last ten containers 18) are reloaded from the data store 12 and, if necessary, further filled with new drilling process data points 30. This allows aborted cycles 60 to be resumed—for example, this occurs when the operator's workday ends before the operator was able to complete cycle 60. For a new cycle 60, a new container 18 is created and filled with the drilling process data points 30.

In principle, the method according to the disclosure can be carried out with archived sensor or machine data 16 or with streaming data, directly on the civil engineering machine, locally on a PC or in a cloud. This is provided that a corresponding software and hardware infrastructure is available.

In the following, a specific example of the cycle allocation according to the disclosure will now be described.

For the rule-based allocation of the data of the detected cycle phase to the respective cycles (container/data structure 18), for example, the signals “rope length” (kelly rope length in kelly drilling) and/or “rotation angle” and/or “GPS positions” of the machine can be used. Depending on the availability of corresponding sensors with sufficient accuracy, at least one of the mentioned signals is used for the cycle phase allocation (preferably GPS positions of the civil engineering machine and/or a tool of the civil engineering machine).

For example, the rule-based approach can proceed according to the following scenarios:

1. The data structure 18 of the cycles does not yet exist or is empty (no cycle phases have been allocated yet). Machine data 16 of the first recognized cycle phase (e.g. drilling, milling, etc.) are stored and numbered in a newly created data structure 18, for example as “cycle 1”. No rule application is yet necessary here.

2. Data structures 18 are stored in a data storage 12 and contain machine data 16 (past or historical) cycle phases and cycle information.

2.1 Part of the data structures 18 is loaded (e.g. data structures 18 with the last ten cycles).

2.2 Machine data 16 of the first or next detected cycle phase are allocated to one of the (e.g. ten) cycles if:

$$( {min}_{i} \vert {gps}_{j} - {gps}_{i} \vert ) < {ε}_{g}$$

$$and / or$$

$$( {min}_{i} \vert {s}_{j} - {s}_{i} \vert ) < {ε}_{g}$$

$$and / or$$

$$( {min}_{i} \vert {w}_{j} - {w}_{i} \vert ) < {ε}_{w}$$

with:
gpsⱼ as GPS positions of the currently detected cycle phase,
gpsᵢ as GPS positions of one of the (previous or historical) cycles i in the data structure,
∈_{g} as a defined maximum permissible distance of the GPS positions,
sⱼ as the rope length of the currently recognized cycle phase,
sᵢ as the rope length of one of the cycles i in data structure 18,
∈ₛ as the specified maximum permissible difference in rope lengths,
wⱼ as the rotation angle of the currently recognized cycle phase,
wᵢ as the rotation angle of one of the cycles i in the data structure 18,
∈_{W} as a predetermined maximum permissible difference of the rotation angles.

Extensions or alternatives to these allocation rules are conceivable.

For example, if only the GPS positions are available, the rule-based allocation can proceed as follows:
“check which GPS positions in the gpsᵢ data structure are closest to the GPS positions of the current cycle phase gpsⱼ
AND if the deviation of their GPS positions is smaller than a specified distance ∈_{g},
THEN allocate the machine data 16 of the cycle phase to the corresponding cycle”.

Corresponding rules can of course also be provided for rope lengths and/or rotation angles, etc.

During allocation, either the last data saved is overwritten with the new data in data structure 18 (overwritten end values), or the new data is appended (end values as the last entry in data structure 18). The variant is selected depends on the requirements and resources (performance, memory space).

2.3 If one of the conditions is not met, a new cycle (e.g. an eleventh cycle) or a new data structure 18 is generated and the machine data 16 of the currently recognized cycle phase is allocated to it.

2.4 When all available machine data has been run through, the filled data structures 18 are stored in a data storage 12.

The following pseudo code presents the basic idea of the rule-based comparison using a specific example. This may differ in detail—further, more complex conditions, data or performance-optimized structure etc. are conceivable.

| For Zⱼ : | |
|---|---|
| Δm = infinite | |
| _{mztmp} = infinite | |
| i = 0 | |
| FOR mzᵢ in ds DO | |
| i = i + 1 | |
| IF \|mⱼ − mzᵢ \| < Δm | |
| Δm = \|mⱼ − mz \|ᵢ | |
| _{mztmp} = mᵢ | |
| IF Δm< ε | |
| ds[i] ← z ⱼ | # either append or overwrite |
| ELSE | |
| IF i == 0 | |
| ds[1] ← z ⱼ | # create first new data structure 18 |
| ELSE | |
| ds[i + 1] ← z ⱼ | # append new / next data structure 18 |

with:
∈: defined, maximum permissible difference of the machine data 16 (between current machine data 16 and machine data 16 in the data structures 18).
ⱼz: cycle phase currently detected by the classification model (e.g., “active drilling”).
ds: data structures 18 with machine data 16 and cycle information.
ⱼm: as zⱼ associated machine data 16 used for cycle phase allocation.
ᵢmz: as machine data 16 associated with a cycle i (data structure 18) used for cycle phase allocation—comparison with mⱼ
Δm: smallest, absolute difference between mⱼ and mzᵢ
mztmp: cached state of machine data 16 of a cycle i (data structure 18) with the smallest deviation to mⱼ
i, j: indices i, j, where i corresponds to a cycle numbering.

_{i,j}d contain at least data of the kelly rope length for the cycle phase allocation. In addition, GPS positions and/or rotation angles can be included and used—if the signals are present and if the signal accuracy is sufficient. The inclusion of further machine data/signals is of course not excluded.

1. System for automatic recognition of work cycles of a civil engineering machine, comprising:
a data storage on which a classification model generated automatically by a mathematical optimization method is stored,
a detection device by means of which status data concerning a status of the civil engineering machine can be detected,
a cycle phase recognition device which has access to the data storage, which receives machine data based on the detected status data as input data and which is configured to automatically allocate machine data to a first cycle phase based on the classification model, wherein the first cycle phase corresponds to a defined work process of the civil engineering machine,
a cycle allocation device which receives the machine data allocated to the first cycle phase as input data and which is configured to automatically allocate these machine data to a work cycle of the civil engineering machine based on a defined allocation rule, wherein the work cycle is defined by start and end values of at least one measured variable represented by the machine data.

2. System according to claim 1, wherein the classification model was generated by means of a machine learning method, including a supervised machine learning method, based on machine data of the civil engineering machine and known cycle phases.

3. System according to claim 1, wherein the detection device comprises at least one sensor attached to the civil engineering machine, which detects a state variable of the civil engineering machine.

4. System according to claim 1, wherein the detection device comprises one or more of the following sensors:
a sensor for detecting a rope speed,
a sensor for detecting a rope force,
a sensor for detecting a drive pressure,
a sensor for detecting a drive speed,
a sensor for detecting a control signal, including r a drive control signal for a drilling drive.

5. System according to claim 1, wherein the defined work process relates to a drilling process, a casing process, an unloading process, a vibrating process, a pile driving process or a milling process.

6. System according to claim 1, wherein the cycle phase recognition device is configured to allocate machine data to at least two different cycle phases based on the classification model, wherein the cycle allocation device is configured to allocate the machine data allocated to a specific cycle phase to a work cycle of the civil engineering machine in each case based on a predetermined allocation rule.

7. System according to claim 1, wherein the start and end values defining a work cycle relate to a drilling depth, a placement depth, a position of the civil engineering machine, and/or an orientation of the civil engineering machine.

8. System according to claim 6, wherein the cycle allocation device is configured to store at least a part of the machine data allocated to a particular work cycle in an associated data structure, wherein a separate data structure is allocated to each detected work cycle, wherein the cycle allocation device is further configured to store the data structures in a data storage and to read them from there.

9. System according to claim 8, wherein detected start and end values of a measured variable contained in the machine data, including detected start and end drilling depths or start and end insertion depths, as well as associated time stamps are stored in the data structures, wherein further detected machine data are stored in the data structures, including data relating to a detected fuel consumption of the civil engineering machine, a detected position of the civil engineering machine and/or a detected engine power of the civil engineering machine.

10. System according to claim 8, wherein the cycle allocation device is configured to load a predetermined number of stored data structures from a data storage when new machine data is provided, wherein the cycle allocation device is further configured:
in the case where machine data are allocated to a work cycle represented by a loaded data structure already partially filled with machine data, to store said machine data in the loaded data structure, and
in the case that machine data are allocated to a new work cycle which is not represented by any of the loaded data structures, to generate a new data structure for this work cycle and to store said machine data in the new data structure.

11. Civil engineering machine, comprising a detection device of the system according to claim 1, and a controller comprising a cycle phase recognition device and/or a cycle allocation device of the system.

12. Method for automatically recognizing work cycles of a civil engineering machine by means of a system according to claim 1, comprising the steps of:
1) Providing a classification model which has been machine-generated by a mathematical optimization procedure,
2) Providing machine data based on condition data regarding a state of the civil engineering machine detected by a detection device of the civil engineering machine,
3) Allocating machine data to a first cycle phase based on the classification model, wherein the first cycle phase corresponds to a defined work process of the civil engineering machine, and
4) Allocating the machine data, which have been allocated to the first cycle phase, to a work cycle of the civil engineering machine based on a defined allocation rule, wherein the work cycle is defined by start and end values of at least one measured variable represented by the machine data.

13. Method according to claim 12, wherein at least part of the machine data allocated to a specific work cycle are stored in an associated data structure, wherein each recognized work cycle is allocated its own data structure, wherein each completely filled data structure contains at least the detected start and end values of a measured variable contained in the machine data, including detected start and end drilling depths or start and end insertion depths, and associated time stamps.

14. Method according to claim 12, wherein a predetermined number of stored data structures are loaded when new machine data is provided, wherein:
in the case where machine data are allocated to a work cycle represented by a loaded data structure already at least partially filled with machine data, said machine data are stored in the loaded data structure, and
in the case that machine data are allocated to a new work cycle which is not represented by any of the loaded data structures, a new data structure is generated for this work cycle and said machine data are stored in the new data structure.
